(19) United States
(12) Patent Application Publication
(10) Pub. No.: US 2025/0190394 A1
(43) Pub. Date: Jun. 12, 2025

(54) ARTIFICIAL INTELLIGENCE QUERY PROCESSING BY PROCESSING-NEAR-MEMORY STORAGE

(71) Applicant: Samsung Electronics Co., Ltd., Suwon-si (KR)

(72) Inventors: Hyoun Kwon JEONG, Pleasanton, CA (US); Soogil JEONG, Pleasanton, CA (US); Joon Hee CHOI, Campbell, CA (US); Myung June JUNG, Santa Clara, CA (US)

(21) Appl. No.: 18/634,880

(22) Filed: Apr. 12, 2024

Related U.S. Application Data
(60) Provisional application No. 63/608,821, filed on Dec. 11, 2023.

(51) Int. Cl. G06F 15/78; G06F 16/22

(52) U.S. Cl. CPC G06F 15/7821; G06F 16/2282

(57) ABSTRACT

Provided are systems, methods, and apparatuses for artificial intelligence query processing by processing-near-memory storage. In one or more examples, the systems, devices, and methods include receiving, at a first processing-near-memory (PNM) storage device, data and processing, at the first PNM storage device, first values from the data with transposed query values from the data. In one or more examples, the systems, devices, and methods include determining, at the first PNM storage device, a probability distribution of a result of the processing and generating, at the first PNM storage device, an activation value based on the probability distribution, the activation value indicating a correlation between units of text in a query associated with the data.

### CROSS-REFERENCE TO RELATED APPLICATIONS

This application claims the benefit of U.S. Provisional Patent Application Ser. No. 63/608,821, filed Dec. 11, 2023, which is incorporated by reference herein for all purposes.

### TECHNICAL FIELD

The disclosure relates generally to memory systems, and more particularly to artificial intelligence query processing by processing-near-memory storage.

### BACKGROUND

The present background section is intended to provide context only, and the disclosure of any concept in this section does not constitute an admission that said concept is prior art.

Artificial intelligence is a branch of computing that mimics human intelligence and can learn from and adapt to data input. With AI search, the platform learns from data on users to generate automatically the most accurate and relevant search experiences. AI search may include query processing, retrieval, and ranking. Query processing involves analyzing a user's query to understand its intent, scope, and constraints. AI search uses machine learning and algorithms to search and categorize large amounts of data. AI search engines use natural language processing (NLP) and other AI-based algorithms to understand search queries and to provide accurate results.

The above information disclosed in this Background section is only for enhancement of understanding of the background of the disclosure and therefore it may contain information that does not constitute prior art.

### SUMMARY

In various embodiments, described herein include systems, methods, and apparatuses for artificial intelligence query processing by processing-near-memory storage.

In some aspects, the techniques described herein relate to a method of query processing, the method including: receiving, at a first processing-near-memory (PNM) storage device, data; processing, at the first PNM storage device, first values from the data with transposed query values from the data; determining, at the first PNM storage device, a probability distribution of a result of the processing; and generating, at the first PNM storage device, an activation value based on the probability distribution, the activation value indicating a correlation between units of text in a query associated with the data.

In some aspects, the techniques described herein relate to a method, wherein the first PNM storage device includes a memory that stores key-value data from the data. In some cases, the data includes attention data.

In some aspects, the techniques described herein relate to a method, wherein the memory and a processor of the first PNM storage device include an integrated circuit based on the memory being stacked on top of the processor and the memory being communicatively connected to the processor.

In some aspects, the techniques described herein relate to a method, further including: receiving, via a die-to-die (D2D) communication interface, at least a second activation value from a second PNM storage device; and forming a unified activation value based at least in part on a combination of the activation value of the first PNM storage device and second activation value of the second PNM storage device, wherein the D2D communication interface enables the first PNM storage device and the second PNM storage device to communicate.

In some aspects, the techniques described herein relate to a method, further including receiving, from the processing device, a trigger before receiving the data, wherein the trigger includes at least one of a user identifier or layer number information associated with the data.

In some aspects, the techniques described herein relate to a method, wherein the data is a portion of multi-head attention data that is distributed among the multiple PNM storage devices.

In some aspects, the techniques described herein relate to a method, wherein the data includes a portion of query attention data from a first attention layer, a portion of key attention data from a second attention layer, and a portion of value attention data from a third attention layer.

In some aspects, the techniques described herein relate to a method, wherein the data is based on an iteration of activation values generated based on partial outputs generated by the multiple PNM storage devices that are reduced to a unified output.

In some aspects, the techniques described herein relate to a method, wherein the multiple PNM storage devices includes an array of solid-state drives.

In some aspects, the techniques described herein relate to a method, wherein the first PNM storage device is a system on chip die that includes a solid-state drive and at least one processor.

In some aspects, the techniques described herein relate to a method, wherein the first PNM storage device communicatively connects to the processing device via a high-bandwidth expansion bus.

In some aspects, the techniques described herein relate to a method, wherein the processing device includes at least one graphical processing unit (GPU) communicatively connected to high-bandwidth memory.

In some aspects, the techniques described herein relate to a method, wherein the data includes attention data, the first values include key values, the second values include query values, and the key-value data includes a key-value matrix.

In some aspects, the techniques described herein relate to a query processing system, the query processing system including: a processing device communicatively connected to a first processing-near-memory (PNM) storage device, the processing device to transmit data to the first PNM storage device; and the multiple processing-near-memory (PNM) storage devices, the first PNM storage device to: process first values from the data with transposed query values from the data; determine a probability distribution of a result of the processing; and generate an activation value based on the probability distribution, the activation value indicating a correlation between units of text in a query associated with the data.

In some aspects, the techniques described herein relate to a query processing system, wherein the first PNM storage device includes a memory that stores key-value data from the data.

In some aspects, the techniques described herein relate to a query processing system, wherein the memory and a processor of the first PNM storage device include an integrated circuit based on the memory being stacked on top of the processor and the memory being communicatively connected to the processor.

In some aspects, the techniques described herein relate to a query processing system, wherein the first PNM storage device is configured to: receive, via a die-to-die (D2D) communication interface, at least a second activation value from a second PNM storage device; and form a unified activation value based at least in part on a combination of the activation value of the first PNM storage device and second activation value of the second PNM storage device, wherein the D2D communication interface enables the first PNM storage device and the second PNM storage device to communicate.

In some aspects, the techniques described herein relate to a query processing system, wherein the first PNM storage device is configured to: receive, from the processing device, a trigger before receiving the data, wherein the trigger includes at least one of a user identifier or layer number information associated with the data.

In some aspects, the techniques described herein relate to a non-transitory computer-readable medium storing code, the code including instructions executable by a processor of a first processing-near-memory (PNM) storage device to: receive data; process, at the first PNM storage device, first values from the data with transposed query values from the data; determine, at the first PNM storage device, a probability distribution of a result of the processing; and generate, at the first PNM storage device, an activation value based on the probability distribution, the activation value indicating a correlation between units of text in a query associated with the data.

In some aspects, the techniques described herein relate to a non-transitory computer-readable medium, wherein: the first PNM storage device includes a memory that stores key-value data from the data, and the memory and a processor of the first PNM storage device include an integrated circuit based on the memory being stacked on top of the processor and the memory being communicatively connected to the processor.

In some aspects, the techniques described herein relate to a non-transitory computer-readable medium, wherein the code includes further instructions executable by the processor to cause the first PNM storage device to: receive, via a die-to-die (D2D) communication interface, at least a second activation value from the second PNM storage device; and form a unified activation value based at least in part on a combination of the activation value of the first PNM storage device and second activation value of the second PNM storage device, wherein the D2D communication interface enables the first PNM storage device and the second PNM storage device to communicate.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The techniques described herein include multiple advantages and benefits. For example, the AI inference delegation techniques provide scalable memory bandwidth and scalable memory capacity to accommodate increased query lengths and increased number of concurrent users. The AI inference delegation techniques lower system costs by reducing the use of expensive graphical processing unit (GPU) systems. Also, the AI inference delegation techniques support relatively long query sizes with sufficient storage space for advanced generative pre-trained transformers. The AI inference delegation techniques enable query key value (QKV) vector multiplication by a processing-near-memory (PNM) solid state drive (SSD). Also, the AI inference delegation techniques enable softmax and layered normalization operations to be performed in a PNM SSD. The AI inference delegation techniques avoid backing up inactive KV data to external storage. Also, the AI inference delegation techniques minimize communication overhead between a main compute node (e.g., GPU system) and a memory-bandwidth intensive system (e.g., PNM SSD). Accordingly, the AI inference delegation techniques reduce system costs and provide scalable memory bandwidth and capacity for advanced generative pre-trained transformers by enabling the ability to simply add more PNM SSDs to a given system.

### BRIEF DESCRIPTION OF THE DRAWINGS

The above-mentioned aspects and other aspects of the present techniques will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example system in accordance with one or more implementations as described herein.

FIG. 5 illustrates an example system in accordance with one or more implementations as described herein.

FIG. 6 depicts a flow diagram illustrating an example method associated with the disclosed systems, in accordance with example implementations described herein.

FIG. 7 depicts a flow diagram illustrating an example method associated with the disclosed systems, in accordance with example implementations described herein.

While the present techniques are susceptible to various modifications and alternative forms, specific embodiments thereof are shown by way of example in the drawings and will herein be described. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

Artificial intelligence (AI) includes the concept of creating intelligent machines that can sense, reason, act, and adapt. Machine learning (ML) may be a subset of AI that helps build AI-driven applications. Deep learning can be a subset of machine learning that uses artificial neural networks to mimic the learning process of the human brain. Deep learning algorithms can use large amounts of data and complex algorithms to train a model. Neural networks can be the foundation of deep learning algorithms. In machine learning, AI inference can include the process of using a trained model to make predictions. In some cases, AI training can be typically a first step in a two-part process of machine learning. Inference can be faster than training because inference does not include the model adjusting its parameters based on new data. Inference also uses less processing power than training clusters. AI can include AI interference delegation. AI inference delegation techniques provide scalable memory bandwidth and scalable memory capacity to accommodate increased query lengths and increased number of concurrent users.

AI search may include query processing, retrieval, and ranking. In some cases, the systems and methods described herein can include AI query processing by processing-near-memory storage. AI search can process large amounts of data and queries in real time, anticipate user needs based on previous search patterns, deliver accurate and relevant results quickly, automatically refine itself over time, learn from data on users to automatically generate the most accurate and relevant search experiences, etc. AI search systems can process various types of input, including natural language queries, voice commands, images, contextual information, and the like.

The systems and methods described herein may include AI processes based on neural processing units (NPUs). An NPU can be a specialized processor that executes machine learning algorithms. NPUs can also be referred to as AI accelerators or intelligent processing units (IPUs). NPUs improve the inference performance of neural networks. NPUs can be configured to work similarly to the human brain. NPUs can be made up of nerve cells and synapses that transmit and receive signals to and from each other. NPUs can use a data-driven parallel computing architecture to process large amounts of multimedia data, like images and videos. NPUs may be used to offload specific workloads, allowing dedicated hardware to focus on more specialized tasks.

In some examples, the systems and methods may include an attention network. An attention network may include a machine learning technique that identifies the strongest correlations between words in a sentence. An attention network can does this by learning patterns from a training corpus. Attention models may evaluate inputs to identify the most important components and assign each a weight. For example, when translating a sentence, an attention model may select the most important words and assign them a higher weight. Attention mechanisms can be additive or dot-product. Additive attention may use a feed-forward neural network to calculate the compatibility between the query and key vectors. Dot-product attention may use a dot product to measure their similarity. Attention mechanisms can also be self-attention. Self-attention can include a mechanism used in machine learning, particularly in natural language processing (NLP) and computer vision tasks. Self-attention can allow the model to identify and weigh the importance of different parts of the input sequence and how the different parts relate to one another (e.g., relevance between the different parts of the input sequence or tokens). In some examples, the systems and methods of the present application may incorporate attention networks to perform AI inference delegation techniques described herein.

In some cases, the systems and methods may include machine learning (ML)-based attention. ML-based attention can be a mechanism mimicking cognitive attention. An attention network may calculates “soft” weights for each word, more precisely for its embedding, in the context window. An attention network can compute either in parallel (such as in transformers) or sequentially (such as recurrent neural networks). Soft weights can change during each runtime, in contrast to hard weights, which are (pre-) trained and fine-tuned and remain frozen afterwards. An attention network may be designed to identify the highest correlations among words of a sentence, assuming that the attention network has learned those patterns through training. Such correlations may be captured in neuronal weights through back-propagation either from self-supervised pretraining or supervised fine-tuning.

In machine learning, the query, key, and value (QKV) in attention networks can be used to model relationships between words. In some examples, the systems and methods described herein enable QKV vector multiplication by a processing-near-memory (PNM) solid state drive (SSD). Attention networks can assign weights to words in a sentence, giving more weight to relevant words. The assigned weights can help preserve the context of the sentence and improve the accuracy of predictions. QKV enables an attention network to focus on what are considered the most important parts of the input and generate output that is relevant and coherent. The attention operation can be thought of as a retrieval process. For example, when searching for a video online, the query is the text in the search bar, the keys are the video title and description, and the values are the videos that match the query. In AI transformers, the query is the information being searched for, the key is the context or reference, and the value is the content being searched. The query and key may be multiplied together to produce attention scores, which are then used to compute the weighted sum of the values.

In some examples, the systems and methods described herein may incorporate multi-head attention (MHA). MHA can be a type of attention mechanism that uses multiple attention layers to process information from an input sequence. MHA can allow a neural network to control how information is mixed between pieces of an input sequence. This can lead to richer representations and improved performance on machine learning tasks. In some cases, MHA includes one or more modules configured for attention mechanisms that run through an attention mechanism several times in parallel. In some cases, the independent attention outputs are concatenated and linearly transformed into the expected dimension. MHAs allow for attending to parts of the sequence differently (e.g., longer-term dependencies versus shorter-term dependencies). Multi-head attention may include multiple attention layers (heads) in parallel. Each head may have different linear transformations on the queries, keys, values, and outputs. For example, one head might focus on the relationship between people, while another head might focus on the context of the sentence, etc. Multi-head attention combines knowledge of the same attention pooling via different representation subspaces of queries, keys, and values. To compute multiple heads of multi-head attention in parallel, proper tensor manipulation may be used.

In some examples, the systems and methods described herein enable softmax and layered normalization operations to be performed in a PNM SSD. The softmax function can include a function that turns a vector of K real values into a vector of K real values that sum to 1 (e.g., into a probability distribution of K possible outcomes). The input values can be positive, negative, zero, or greater than one, and the softmax transforms them into values between 0 and 1, so that they can be interpreted as probabilities. The softmax function can provide probability values that range between 1 and 0 (e.g., 0, 0.0925, 0.1, 0.95, 1, etc.), while the Max function may only give a binary output of 1 for max and 0 otherwise, with no possible values between. The softmax activation function may be a mathematical function that converts a vector of real numbers into a probability distribution. The softmax function may be used as the activation function in the output layer of neural network models that predict a multinomial probability distribution. The softmax activation function may be used for multi-class classification problems where class membership is used on more than two class labels. The softmax function can exponentiate each element, making them positive, and then normalizes them by dividing by the sum of all exponentiated values. The output of a Softmax can be a vector with probabilities of each possible outcome. The probabilities in vector v sums to one for all possible outcomes or classes. The Softmax function may be an extension of the Sigmoid function. Sigmoid can be used for binary classification methods where there are two classes.

The systems and methods described herein may include an activation function. The activation function may be a function in a neural network that is used to determine the output of a neuron. In some cases, an activation value may be based on a probability distribution. The activation value may indicate a relevance between units of text in a query associated with the attention data. An AI system may determine whether a neuron is activated or not based on a weighted sum of inputs. In some cases, the systems and methods may include layer normalization. Layer normalization may be a technique for normalizing the activations of a neural network layer. Layer normalization can work by normalizing the activations for each individual sample in a batch, by subtracting the mean and dividing by the standard deviation. Examples of activation functions may include tanh function, sigmoid function, exponential linear unit (ELU), linear activation function, maxout, and binary step activation function. The tanh function may be a non-linear activation function that can be used between layers of a neural network. The tanh function has a similar shape to the sigmoid function, but its range is −1 to 1. The sigmoid activation function may be used in neural networks. The sigmoid function may be applied to each neuron's output, allowing the network to introduce non-linearity into the model. The ELU activation function can be used for nonlinear estimation. The output layer of the ELU activation function can include a single node, and yields an estimated level from the given inputs. The linear activation function is a simple straight line activation function where the function is directly proportional to the weighted sum of neurons or input. With the maxout function, non-linearity may be applied as a dot product between the weights of a neural network and data. The binary step function can be used as an activation function while creating a binary classifier.

In some examples, the systems and methods may include large language models (LLMs) LLMs may include a type of AI algorithm (e.g., deep learning algorithm) that can understand, summarize, generate, and predict new content. LLMs may use statistical models to analyze large amounts of data, learning patterns and connections between words and phrases. LLMs may be built on machine learning, specifically a type of neural network called a transformer model. In some cases, the systems and methods implement transformer models with LLMs.

In some cases, an LLM may include a feedforward layer (FFN), which is made of up multiple fully connected layers that transform the input embeddings. In so doing, these layers enable the model to glean higher-level abstractions (e.g., to understand the user's intent with the text input). Systems and methods described herein may implement Gaussian error linear unit (GELU) as an activation function. The GELU activation function can be xΦ(x), where Φ(x) is the standard Gaussian cumulative distribution function. Dropout regularization stochastically multiplies a neuron's inputs with 0, randomly rendering them inactive. ReLU activation deterministically multiplies inputs with 0 or 1 dependent upon the input's value. GELU merges dropout regularization and rectified linear unit (ReLU) by multiplying inputs by a value from 0 to 1. However, the value of this zero-one mask, while stochastically determined, may also be dependent upon the input's value.

In some cases, the systems and methods may implement an LLM that includes a reduce layer. For example, a map reduce documents chain first applies an LLM chain to each document individually (the map step), treating the chain output as a new document. The LLM then passes all the new documents to a separate combine documents chain to get a single output (the reduce step).

In some cases, the systems and methods described herein may be based on recurrent neural networks (RNNs). RNNs may be a type of artificial neural network that is designed to process sequential data. RNNs can recognize sequential characteristics in data and use patterns to predict the next likely scenario. RNNs may have feedback connections that allow them to retain information from previous time steps. This enables RNNs to capture temporal dependencies. RNNs can be made up of a series of repeating neural network cells that are connected in a chain-like structure. The output of one cell is passed as input to the next cell.

In some cases, AI inference delegation system and methods described herein are based on tokens. Tokens can be fundamental units of text or code that AI models (e.g., LLMs) use to process and generate language. Tokenization is splitting input/output texts into smaller units for LLM AI processing. Vocabulary size is the number of tokens each model uses, which varies among different models. Examples of tokens include characters, words, subwords, other segments of text or code, punctuation, parts of words, partial sentences, phrases, etc. The tokenization method or scheme used determines the type of token. In some examples, the phrase [I love you.] may have five tokens: [I], [love], [you], [ ], and [.]. Tokens may be converted into an embedding, which the LLM model then processes to understand the text. Each LLM has a maximum limit on the number of tokens it can process.

In some examples, the systems and methods may be based on key-value caching (KV caching). KV caching can include a method of storing data temporarily to improve application response times. KV caching involves caching frequently accessed data in a key-value store. KV caching reduces database queries, complex computations, and saves compute resources by reusing previously calculated attention key-value pairs, instead of recalculating them for each generated token. Key and value states are used for calculating scaled dot-product attention. A decode phase can generate a single token at each time step, but each token depends on the key and value tensors of all previous tokens (including the input token KV tensors computed at prefill, and any new KV tensors computed until the current time step). At each token generation step, the Query vector of a single current token may be multiplied by the Key vectors of all previous tokens in the sequence to create attention scores, and the scores are further multiplied by the Value vectors of all previous tokens. Thus, instead of re-computing the Key and Value vectors for all previous tokens at each token generation step, KV caching may be based on performing only incremental computation for a current token and re-using previously computed Key/Value vectors from the KV-cache. The KV vector of the current token can also be appended to the KV-cache for the next token generation step. The AI inference delegation systems and methods described herein may support relatively long query sizes with sufficient storage space for advanced generative pre-trained transformers.

In some cases, the systems and methods implement near-memory computing (NMC). NMC may be a system architecture that moves the compute capability at or near memory (e.g., random access memory (RAM)). This allows for memory-centric computing and addresses the central processing unit (CPU)-memory bandwidth bottleneck. NMC can include processing-near-memory (PNM) and processing-in-memory (PIM). PIM can improve performance and energy efficiency by offloading some of the data calculation tasks from the CPU to inside the memory. PIM can allow computations and processing to be performed within the memory of a computer, server, or similar device. PNM may incorporate memory and logic chips (e.g., processing units) into an integrated circuit package (e.g., system on chip (SoC)) that reduces data movement between CPU and memory by utilizing memory for data calculation, resulting in improved system performance and increased energy efficiency. PNM may enable calculation functions (e.g., AI processing) to be performed closer to the memory in order to reduce the bottleneck that occurs between the CPU and memory data transference. PNM may be applied in caching, multi-threading, embedded random-access memory, and AI processing to mitigate the CPU memory bottleneck problem.

A solid-state drive (SSD) may include a non-volatile storage media that stores persistent data on solid-state flash. A PNM SSD is an SSD that incorporates PNM. Thus, a PNM SSD can incorporate memory and logic chips in an integrated circuit package (e.g., SoC, an SoC SSD with memory, logic chips, processing units, microcontrollers, solid-state flash, etc.). A system on chip (SoC) may be an integrated circuit (IC) that includes the components of a computer system. A SoC may include at least one of a central processing unit (CPU), a field programmable gate array (FPGA), a graphic processing unit (GPU), random access memory (RAM), storage (e.g., SSD), network interfaces, input/output (I/O) ports, peripheral interfaces, secondary storage devices, and/or I/O drivers, etc. A system in package (SiP) can be a method for bundling multiple ICs (e.g., multiple SoCs) and passive components into a single package. The SiP can perform the functions of an entire system. The AI inference delegation systems and methods described herein lower system costs by using PNM SSDs and reducing the use of expensive graphical processing unit (GPU) systems.

In some cases, the systems and methods described herein may implement a RAM channels. The RAM channel may refer to an aspect of memory architecture called the memory channel. The memory channel may be the number of channels of communication available between a RAM module and the memory controller. The memory controller can be the digital circuitry that manages the flow of data to and from the RAM module. The rank of the RAM may be concerned with the number of sets of memory chips the module contains. The memory channels of the RAM can enable the memory controller to access the various ranks of RAM, providing a data conduit between the RAM and the CPU. Multichannel memory architecture can increase the number of channels the memory controller can use, producing an increase in the data transfer rate. A dynamic RAM (DRAM) channel may include a controller interface that can communicate with one or more ranks. A DRAM channel may be a common group of address/data lines that function together. The systems and methods may implement through-silicon via (TSV). TSV can include a chip packaging technology that vertically connects integrated chip dies (e.g.,, processors, DRAM chip dies, etc.). TSV may be an alternative to wire-bond and flip chips to create 3D packages and 3D integrated circuits. Hybrid copper bonding is a process that connects dies in packages using copper-to-copper connections. Hybrid copper bonding may be used for packages with relatively small pitches (e.g., 10 μm pitches and below).

Some AI Inferencing systems (e.g., generative AI, generative pre-trained transformers, LLMs, etc.) can encounter performance obstacles associated with memory bandwidth and memory capacity. As the length of a query grows and/or as the number of concurrent users increases, AI inferencing systems can reach a limit of memory bandwidth and/or memory capacity. In some cases, QKV data processing can be a limiting factor in concurrent user and/or query length scalability.

With transformer attention systems, user query processing (e.g., QKV processing) can include relatively high memory bandwidth and/or memory capacity constraints based on the potential for encountering relatively long query lengths. However, in some cases, QKV processing may be associated with relatively low computational constraints (e.g., low computational load).

Some approaches use a main processing unit (e.g., GPU, CPU of a high-performance computing system etc.) to compute weight operations and QKV operations (e.g., all processes of a transformer attention system). As generative pre-trained transformers advance, the query length steadily increases (e.g., progressing from a 2K query length to a 120K query length). Storage space constraints are increasing to handle longer query lengths and increased number of concurrent users. High bandwidth memory (HBM) may be used, but HBM is capacity limited and host cloud storage may be too slow to handle the increased memory bandwidth and memory capacity constraints.

Because weight operations are more computationally intensive than memory intensive (e.g., weight operations involve relatively high processing levels), weight operations are better performed by a main processing unit (e.g., CPU, GPU) of a computational node. Because QKV operations are more memory intensive than computationally intensive (e.g., QKV operations involve relatively high memory bandwidths and/or memory capacities), QKV operations are better performed by a processing-near-memory (PNM) storage device.

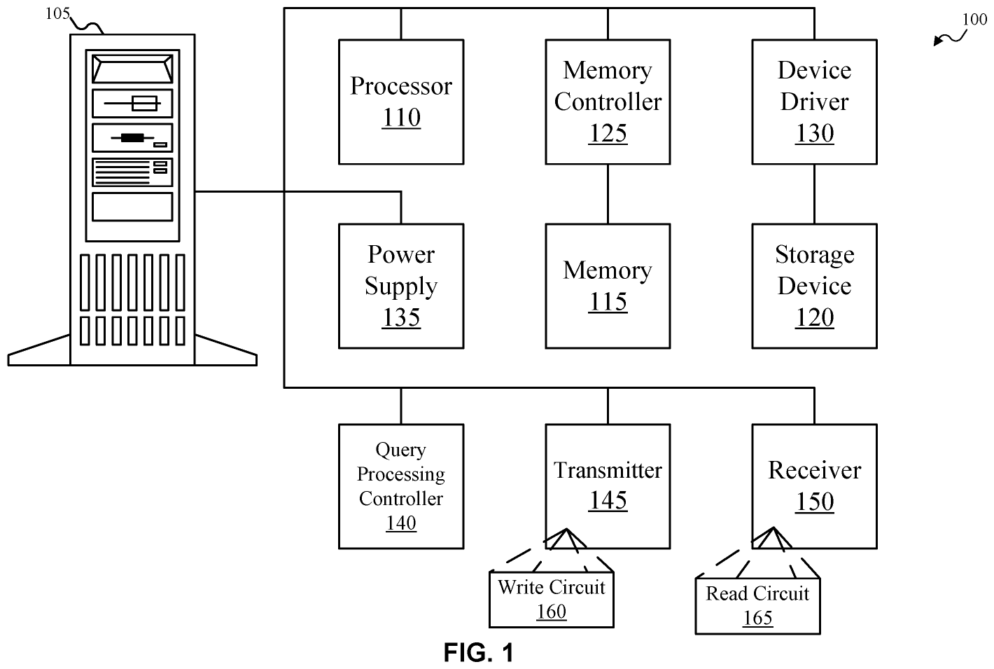

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe®) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data (e.g., query processing data). In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, in memory 115 and/or storage device 120.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced extensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, query processing controller 140 functionality, and/or the like, may be implemented with hardware, software, firmware, or any combination thereof including, for example, hardware and/or software combinational logic, sequential logic, timers, counters, registers, state machines, volatile memories such as dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), graphics processing units (GPUs), neural processing units (NPUs), tensor processing units (TPUs) and/or the like, executing instructions stored in any type of memory. In some embodiments, one or more components of query processing controller 140 may be implemented as a system-on-chip (SoC).

In some examples, query processing controller 140 may include any one or combination of logic (e.g., logical circuit), hardware (e.g., processing unit, memory, storage), software, firmware, and the like. In some cases, query processing controller 140 may perform one or more functions in conjunction with processor 110. In some cases, at least a portion of query processing controller 140 may be implemented in or by processor 110 and/or memory 115. The one or more logic circuits of query processing controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable query processing controller 140 to provide artificial intelligence query processing by processing-near-memory storage.

In one or more examples, query processing controller 140 may provide artificial intelligence query processing in conjunction with processing-near-memory storage. For example, query processing controller 140 may provide the AI inference delegation techniques described herein. In one or more examples, query processing controller 140 receives attention data from a GPU processing device, processes key values from the attention data with transposed query values from the attention data, determines a probability distribution of a result of the processing, and generates an activation value (e.g., activation values, activation vector) based on the probability distribution, the activation value indicating a relevance between units of text in a query associated with the attention data. Accordingly, query processing controller 140 provides scalable memory bandwidth and scalable memory capacity to accommodate increased query lengths and/or increased number of concurrent users, thereby lowering system costs by reducing the use of relatively expensive graphical processing unit (GPU) compute-intensive systems, avoiding backing up inactive KV data to external storage, and minimizing communication overhead between a main compute node (e.g., GPU system) and a relatively high memory-bandwidth system (e.g., PNM SSD array).

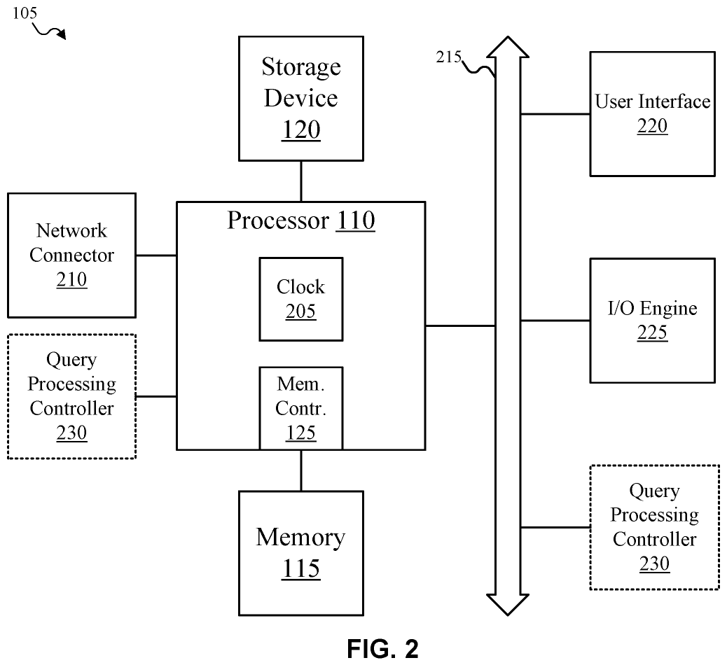

FIG. 2 illustrates details of machine 105 of FIG. 1, according to examples described herein. In FIG. 2, typically, machine 105 includes one or more processors 110, which may include memory controllers 125 and clocks 205, which may be used to coordinate the operations of the components of the machine. Processors 110 may be coupled to memories 115, which may include random access memory (RAM), read-only memory (ROM), or other state preserving media, as examples. Processors 110 may be coupled to storage devices 120, and to network connector 210, which may be, for example, an Ethernet connector or a wireless connector. Processors 110 may be connected to buses 215, to which may be attached user interfaces 220 and Input/Output (I/O) interface ports that may be managed using I/O engines 225, among other components. As shown, processors 110 may be coupled to query processing controller 230, which may be an example of query processing controller 140 of FIG. 1. Additionally, or alternatively, processors 110 may be connected to buses 215, to which may be attached query processing controller 230.

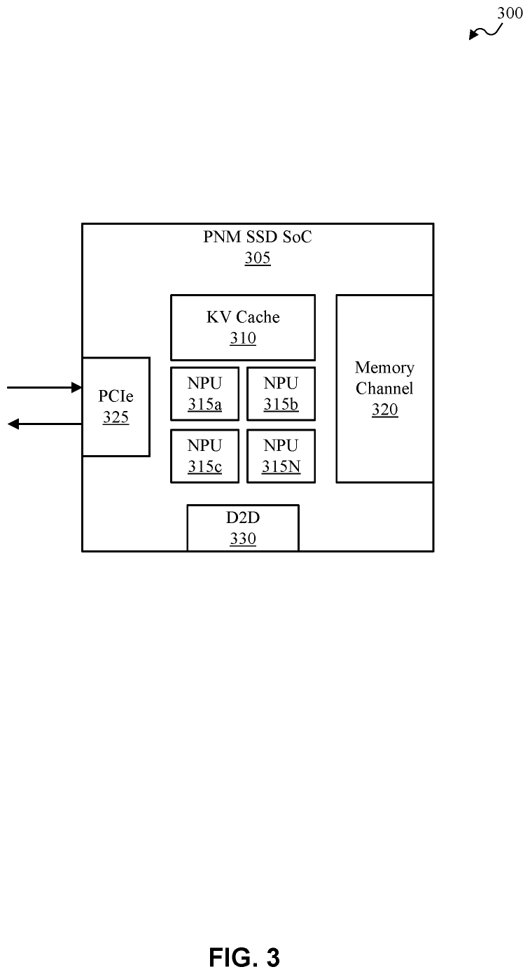

FIG. 3 illustrates an example system 300 in accordance with one or more implementations as described herein. In one or more examples, system 300 illustrates an example system of artificial intelligence query processing via processing-near-memory storage. In the illustrated example, system 300 may include PNM SSD SoC 305. As shown, PNM SSD SoC 305 may include key value (KV) cache 310, at least one NPU 315, memory channel 320, communication interface 325 (e.g., PCIe communication interface), at least one interconnect 330 (e.g., one or more die-to-die (D2D), chip-to-chip (C2C), chiplet-to-chiplet, SoC interconnects, etc.). As shown, PNM SSD SoC 305 may include at least one NPU (e.g., NPU 315a, NPU 315b, NPU 315c to NPU 315N), where N is a positive integer. Memory channel 320 may include a persistent memory channel (e.g., flash memory, SSD, etc.) and/or a DRAM channel (e.g., RAM, SRAM, etc.), etc. In some examples, one or more components of system 300 (e.g., PNM SSD SoC 305, KV cache 310, at least one NPU, memory channel 320, etc.) may incorporate and/or function in conjunction with query processing controller 140 of FIG. 1 and/or query processing controller 230 of FIG. 2. In some cases, KV cache 310, NPU 315a to NPU 315N, and memory channel 320 may be configured to perform artificial intelligence query processing (e.g., QKV processing) based on the processing-near-memory storage capabilities of system 300.

Weight operations (e.g., weight matrix operations) are more constrained by computational performance (e.g., as measured in teraflops) than by memory bandwidth. However, QKV operations are more constrained by memory bandwidth and/or memory capacity than computational performance. Accordingly, the techniques described herein delegate weight processing to one or more processing units (e.g., CPUs, GPUs of main compute nodes, etc.) and delegate QKV processing to one or more PNM storage devices (e.g., PNM SSD, PNM SSD SoC, PNM SSD SoC array) such as PNM SSD SoC 305. Accordingly, the PNM SSD SoC 305 may be configured to perform QKV processing for an LLM query while a processing unit (e.g., GPU compute-intensive system) may process the weight operations of the LLM query.

In one or more examples, PNM SSD SoC 305 may be configured to support relatively long query lengths with sufficient storage space for advanced AI inferencing systems, generative AI, generative pre-trained transformers, LLMs, etc. The PNM SSD SoC of system 300 is configured to perform query processing (e.g., QKV vector multiplication) for one or more queries while a compute-intensive system (e.g., GPU system with high-bandwidth memory) performs weight processing for the one or more queries. The PNM SSD SoC 305 may be configured to perform softmax functions and layered normalization operations (e.g., offloading a main processing unit, a processing unit of a compute intensive hardware system).

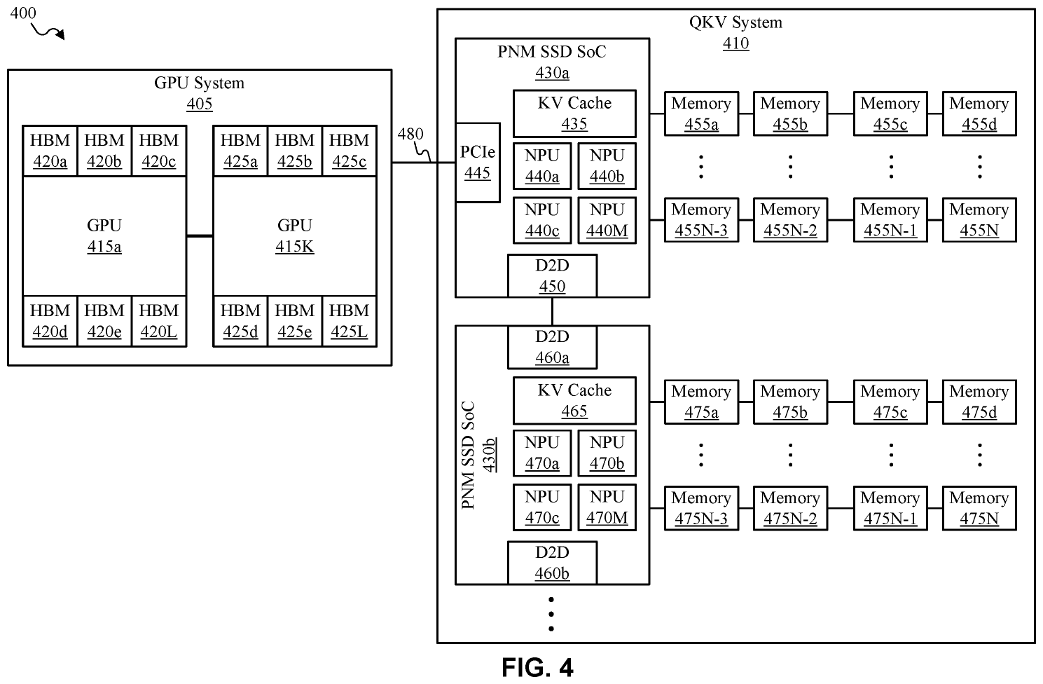

FIG. 4 illustrates an example system 400 in accordance with one or more implementations as described herein. In the illustrated example, system 400 may include GPU system 405 and QKV system 410. GPU system 405 may be configured as a compute-intensive GPU-based system for weight matrix multiplication. QKV system 410 may be configured as a scalable QKV processing system. As shown, GPU system 405 may include at least one GPU (e.g., GPU 415a to GPU K, where K is a positive integer). In some examples, one or more components of system 400 (e.g., GPU system 405, QKV system 410, one or more components of GPU system 405, and/or one or more components of QKV system 410) may incorporate and/or function in conjunction with query processing controller 140 of FIG. 1 and/or query processing controller 230 of FIG. 2.

As shown, GPU 415a may include at least one HBM (e.g., HBM 420a, HBM 420b, HBM 420c, HBM 420d, HBM 420e, to HBM 420L, where L is a positive integer). As shown, GPU 415K may include at least one HBM (e.g., HBM 425a, HBM 425b, HBM 425c, HBM 425d, HBM 425e, to HBM 425L). As shown, each GPU may include L units of HBM, where L is a positive integer. In some cases, GPU 415K may have less or more HBM units than GPU 415a.

In the illustrated example, GPU system 405 connects to QKV system 410 via at least one instance of communication interface 480. Communication via communication interface 480 may flow from GPU system 405 to QKV system 410 and/or from QKV system 410 to GPU system 405. In some cases, communication interface 480 may implement the NVMe protocol (e.g., 16 GB/s for up to 300 users per instance of communication interface 480). In some cases, GPU system 405 may communicate values or vectors of Q, K, and/or V to QKV system 410 (e.g., vector Q[N], vector K[N], vector V[N], where N for QKV values is a positive integer that depends on query length and/or number of users, and may be independent of other instances of N used as an integer herein). In some cases, QKV system 410 may communicate activation values to GPU system 405 (e.g., vector activation [N], where N for activation values is a positive integer). In this case, N may be independent of other uses or other instances herein of the variable N (e.g., N number of memory modules is different from N in activation [N]). As far as Q[N], K[N], V[N], and activation [N], N may be the number of concurrent users and/or queries in a batch process. In some cases, N may change (e.g., increase, decrease) with each iteration of query processing. With each iteration, the QKV values received by the QKV system 410 may be based on (e.g., updated based on, adjusted based on) attention data from a previous iteration (e.g., updated attention data).

As shown, QKV system 410 includes at least one PNM SSD SoC (e.g., PNM SSD array that includes PNM SSD SoC 430a, PNM SSD SoC 430b, etc.). In some cases, PNM SSD SoC 430a is a system on chip die that includes a solid-state drive and at least one processor. In some cases, PNM SSD SoC 430b is a system on chip die that includes a solid-state drive and at least one processor. The number of PNM SSD SoCs in QKV system 410 may be based on a determined demand at any given time (e.g., adding and/or activating PNM SSD SoCs, pluggable PNM SSD SoCs, hot-swappable PNM SSD SoCs, etc., based on demand). In some cases, the number of PNM SSD SoCs in QKV system 410 may increase as demand (e.g., number of queries, number of users) increases over time.

In the illustrated example, PNM SSD SoC 430a includes KV cache 435 and at least one NPU (e.g., NPU 440a, NPU 440b, NPU 440c, to NPU 440M, where M is a positive integer). As shown, PNM SSD SoC 430a may include communication interface 445 (e.g., PCle communication interface) and interconnect 450 (e.g., D2D, C2C, SoC interconnect, etc.). Communication interface 445 may be an example of communication interface 325. Interconnect 450 may be an example of interconnect 330. As shown, communication interface 445 may enable communication between GPU system 405, QKV system 410, PNM SSD SoC 430a, and/or PNM SSD SoC 430b.

In the illustrated example, PNM SSD SoC 430b includes KV cache 465, at least one NPU (e.g., NPU 470a, NPU 470b, NPU 470c, to NPU 470M, where M is a positive integer). In some cases, PNM SSD SoC 430b may have more or less NPUs relative to PNM SSD SoC 430a. In some cases, PNM SSD SoC 430b may include interconnect 460a and interconnect 460b (e.g., D2D, C2C, SoC interconnects). As shown, interconnect 460a may enable PNM SSD SoC 430b to communicate with PNM SSD SoC 430a (e.g., D2D, C2C, SoC interconnect communication, etc.). As shown, interconnect 460b may enable PNM SSD SoC 430b to communicate with another PNM SSD SoC added to QKV system 410 (e.g., via D2D, C2C, SoC interconnect communication, etc.). In some examples, QKV system 410 includes multiple PNM SSD SoC dies (e.g., PNM SSD SoC 430a, PNM SSD SoC 430b, etc.) that are clustered in a system in package (SiP) via D2D interconnect (e.g., interconnect 450, interconnect 460a, interconnect 460b, etc.).

In one or more examples, each PNM SSD SoC may include an array of memory modules (e.g., NAND flash, DRAM, other type of persistent or non-persistent memory). In the illustrated example, PNM SSD SoC 430a may connect to and/or include at least one unit of memory (e.g., memory 455a, memory 455b, memory 455d, to memory 455N, where N is a positive integer). The memory of PNM SSD SoC 430a (e.g., memory 455a to memory 455N) may be an example of memory channel 320. In the illustrated example, PNM SSD SoC 430b may connect to and/or include at least one unit of memory (e.g., memory 475a, memory 475b, memory 475d, to memory 475N, where N is a positive integer).

In some examples, system 400 delegates computation of weight processing of a query (e.g., batch of queries) to GPU system 405 and QKV processing of the query (e.g., batch of queries) to QKV system 410. In some cases, QKV system 410 stores Key-Value matrices (KV matrices associated with QKV processing) via the PNM SSD array, enabling processing of relatively large-scale query lengths and/or concurrent users associated with increasingly advanced generative pre-trained transformers. Based on QKV system 410, there is no need to backup inactive KV data to external storage, as with some approaches. Instead, KV data is maintained in KV cache (e.g., KV cache 435, KV cache 465).

In one or more examples, KV cache 435 and/or KV cache 465 may be on-die cache memory (e.g., cache memory, SRAM, etc.) configured for buffering or storing key-value matrices (KV matrices and/or key-value tables associated with QKV processing). In some cases, KV cache 435 and/or KV cache 465 may be implemented to avoid redundant loading a key-value table from NAND (e.g., NAND being slower than cache memory such as KV cache). In some examples, KV cache 435 and/or KV cache 465 may include on-die cache that is built on a respective PNM SSD SoC based on a 3D-stacking process (e.g., through-silicon via (TSV), hybrid copper bonding, etc.). In some cases, KV cache 435 and a processor PNM SSD SoC 430a (e.g., at least one of NPU 440a, NPU 440b, NPU 440c, to NPU 440M) may be formed as a stacked integrated circuit based on KV cache 435 being stacked on top of the processor and KV cache being communicatively connected to the processor. For example, at least a portion of KV cache 435 may be stacked on top of NPU 440a and KV cache 435 may be communicatively connected to NPU 440a by one or more vertical connections running between KV cache 435 and NPU 440a.

The memory of PNM SSD SoC 430b (e.g., memory 475a, memory 475b, memory 475d, to memory 475N) may be an example of memory channel 320. In some cases, the number of memory units connected to PNM SSD SoC 430b (e.g., memory 475a, memory 475b, memory 475d, to memory 475N) may be less or more than the number of memory units connected to PNM SSD SoC 430a (e.g., memory 455a, memory 455b, memory 455d, to memory 455N). In some examples, the at least one unit of memory of PNM SSD SoC 430a may be at least partially incorporated on PNM SSD SoC 430a. In some cases, the at least one unit of memory of PNM SSD SoC 430b may be at least partially incorporated on PNM SSD SoC 430b. In some examples, the at least one unit of memory of PNM SSD SoC 430a may be NAND flash, DRAM memory, or another type of persistent memory and/or non-persistent memory. In some cases, the at least one unit of memory of PNM SSD SoC 430b may be NAND flash or another type of persistent and/or non-persistent memory.

In one or more examples, system 400 illustrates an example of a QKV processing system for artificial intelligence query processing via processing-near-memory storage. As shown, GPU system 405 may be configured to process weight operations (e.g., weight quantization) associated with a query (e.g., a batch of queries). In some examples, the PNM SSD array of QKV system 410 (e.g., PNM SSD SoC 430a, PNM SSD SoC 430b, etc.) may be configured to process QKV operations (e.g., QKV matrix multiplication) associated with the query (e.g., the batch of queries). Each PNM SSD SoC of QKV system 410 offers both relatively high memory/storage bandwidth and memory/storage capacity. Accordingly, increased memory/storage bandwidth and memory/storage capacity constraints may be met simply by adding one or more additional PNM SSD SoCs to QKV system 410 (e.g., pluggable PNM SSDs, hot-swappable PNM SSDs). Accordingly, QKV system 410 provides a scalable system configured to adapt to increasing query lengths and/or number of concurrent users with relatively low cost.

Based on QKV system 410, multiple PNM SSD dies may be clustered through D2D interconnects. For example, interconnect 450 may enable PNM SSD SoC 430a to connect to PNM SSD SoC 430b via interconnect 460a. Similarly, interconnect 460b may enable PNM SSD SoC 430b to connect to another PNM SSD SoC, providing a cluster of interconnected PNM SSD SoCs for QKV processing. In some cases, the PNM SSD SoCs (e.g., SoC dies) of QKV system 410 may be clustered in a system in package (SiP), enabling a PNM SSD SoC (e.g., PNM SSD SoC 430a) to send and/or receive partial compute results to one or more other PNM SSD SoC (e.g., PNM SSD SoC 430b) without host communication (e.g., bypassing GPU system 405 and/or a host).

Based on QKV system 410, KV matrices (e.g., of one or more queries, a batch of queries, etc.) may be distributed to one or more of the PNM SSD SoCs. For example, a first portion of the KV matrices of one or more queries may be distributed to PNM SSD SoC 430a, a second portion of the KV matrices of the one or more queries may be distributed to PNM SSD SoC 430b, a third portion of the KV matrices of the one or more queries may be distributed to another PNM SSD SoC (e.g., connected to PNM SSD SoC 430b), and so on.

Each PNM SSD SoC of QKV system 410 may be configured to perform query processing on a portion of the KV matrices (e.g., perform partial matrix multiplication). A PNM SSD SoC may be configured to perform one or more reduction operations in coordination with one or more other PNM SSD SoCs (e.g., based on the partial matrix multiplication performed by the two or more PNM SSD SoCs). The reduction operations between the two or more PNM SSDs (e.g., between at least PNM SSD SoC 430a and PNM SSD SoC 430b, etc.) may be performed based on the D2D interconnects of the two or more PNM SSD SoCs.

To minimize loading latency with respect to the memory of the PNM SSD array (e.g., NAND flash memory), QKV system 410 may preload at least PNM SSD SoC 410a and/or PNM SSD SoC 410b based on a “hint ahead” operation (e.g., issued from a compute-intensive die, issued from GPU system 405, issued from a host system, etc.). For example, GPU system 405 may provide a hint (e.g., a preloading trigger) to QKV system 410 (e.g., before QKV system 410 receives QKV data, receives KV matrices, and/or starts QKV matrix multiplication, etc.). In some cases, the hint may include a user ID (e.g., one or more user IDs) and/or layer number information associated with one or more queries and/or users (e.g., user ID and layer number information associated with a batch of queries/users).

The techniques described herein include query processing logic to provide artificial intelligence query processing by processing-near-memory storage. The query processing logic includes any combination of hardware (e.g., at least one memory, at least one processor), logical circuitry, firmware, and/or software to provide artificial intelligence query processing by processing-near-memory storage. The query processing may relate to artificial intelligence inferencing (e.g., in relation to attention networks).

To accommodate increased query lengths and increased number of concurrent users, the described techniques separate query processing into two parts rather than using only a single system (e.g., an expensive GPU base system). Weight operations are more computationally intensive than memory intensive (e.g., weight operations have relatively high processing constraints). Thus, weight operations are performed by a high-performance computation node (e.g., GPU system 405). QKV operations are more memory intensive than computationally intensive (e.g., QKV operations have relatively high memory bandwidth and/or memory capacity constraints). Thus, QKV operations may be delegated to and performed by a high-memory-bandwidth system (e.g., QKV system 410, PNM SSD SoC 430a, PNM SSD SoC 430b, etc.).

The delegation of weight operations and QKV operations offers better performance and scalability for LLM inferencing compared to some approaches. Based on the techniques described herein, communication overhead between a main compute node (e.g., GPU system) and a memory-bandwidth intensive system (e.g., PNM SSD) is minimized.

In some examples, PNM SSD SoC 430a receives (e.g., via PCle, communication interface 445) attention data from GPU system 405. In some cases, PNM SSD SoC 430a processes key values from the attention data with transposed query values from the attention data and determines a probability distribution of a result of the processing. In some examples, PNM SSD SoC 430a generates an activation value (e.g., activation values, activation vector, Activation [N]) based on the probability distribution. The activation value may indicate a relevance between units of text in a query associated with the attention data.

In one or more examples, PNM SSD SoC 430a receives, via interconnect 450, at least a second activation value (e.g., second activation values, second activation vector) from PNM SSD SoC 430b and forms a unified activation value (e.g., vector Activation2[N]) based at least in part on a combination of the activation value of PNM SSD SoC 430a and second activation value of PNM SSD SoC 430b.

In one or more examples, the attention data received by PNM SSD SoC 430a is a portion of multi-head attention data that is distributed among multiple PNM storage devices of QKV system 410. In some cases, the attention data includes a portion of query attention data from a query multi-head attention layer, a portion of key attention data from a key multi-head attention layer, and a portion of value attention data from a value multi-head attention layer. In some examples, the attention data is based on an iteration of activation values generated based on previous partial outputs generated by the multiple PNM storage devices that are reduced to a unified output.

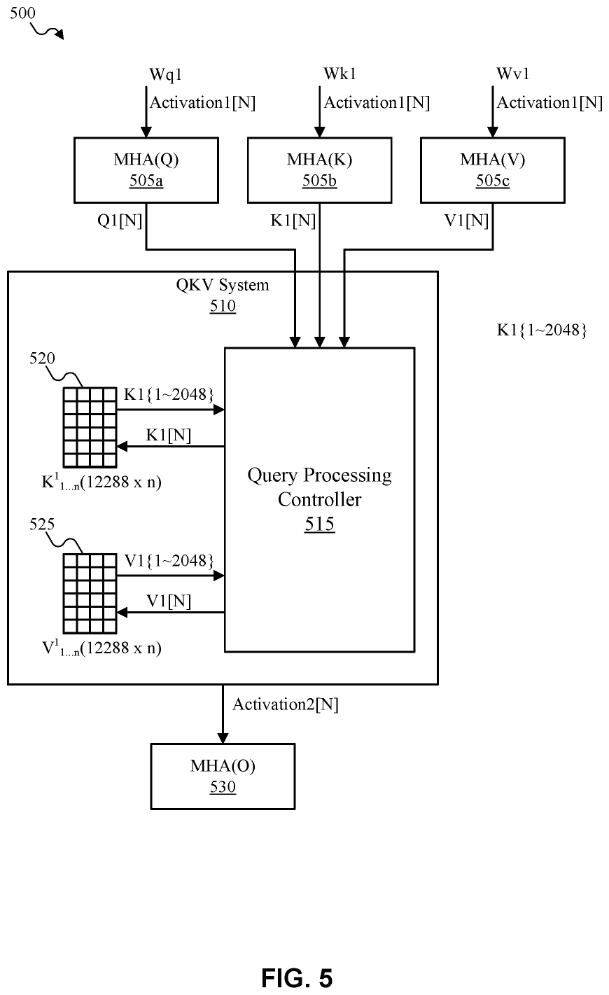

FIG. 5 illustrates an example system 500 in accordance with one or more implementations as described herein. System 500 illustrates an example system of artificial intelligence query processing via processing-near-memory storage. As shown, FIG. 4 depicts a PNM storage device.

In the illustrated example, system 500 includes a query multi-head attention MHA (MHA(Q)) 505a, a key MHA (MHA(K)) 505b, a value MHA (MHA(V)) 505c, QKV system 510, and an output MHA (MHA(O)). In some examples, QKV system 510 is an example of QKV system 410 of FIG. 4. As shown, QKV system 510 includes query processing controller 515. Query processing controller 515 may be an example of query processing controller 140 of FIG. 1 and/or query processing controller 230 of FIG. 2. In some cases, query processing controller 515 may incorporate and/or function in conjunction with one or more PNM SSD SoCs (e.g., a PNM SSD SoC array, PNM SSD SoC 305, PNM SSD SoC 430a, PNM SSD SoC 430b).

In one or more examples, an input query is assigned to a given system (e.g., token index [N], where N indicates the number of concurrent users and/or queries in a batch process). The input query may be provided to an embedding positional encoding process that filters the input query. In some examples, query data from a batch process may be separated into MHA(K) 505a, MHA(V) 505b, and MHA(Q) 505c. In some cases, inputs to MHA(Q) 505c include an activation value (e.g., vector Activation1[N] based on token index [N]) with a query weight (Wq1) applied to the activation value (e.g., query weights applied to a set of activation values). In some examples, inputs to MHA(K) 505a include the activation value with key weights (Wk1) applied to the activation value (e.g., key weights applied to a set of activation values). In some examples, inputs to MHA(V) 505b include the activation value based on value weights (Wv1) applied to the activation value (e.g., value weights applied to a set of activation values). In some cases, a compute-intensive system (e.g., GPU system 405) computes the weight values (e.g., Wq1, Wk1, Wv1).

As shown, MHA(Q) outputs Q1[N], MHA(K) outputs K1[N], and MHA(V) outputs V1[N] into QKV system 510 (e.g., a processing-near-memory (PNM) storage device, an array of PNM SSD SoCs). In some examples, query processing controller 515 performs QKV processing based on inputs Q1[N], K1[N], and V1[N].

As shown, QKV system 510 receives input based on a query (e.g., input vector {K[N], V[N], Q[N]}, where N indicates the number of concurrent user/queries in a batch process). In some cases, N indicates a user_ID associated with a query (e.g., a value of N is a user_ID for a given query). In the illustrated example, query/answers (e.g., all query/answer {K[0:QL], V[0:QL]}, where QL is Query Length such as 2048, 4096, or 8192 characters) are stored and processed in a processing-near memory storage device. For example, vector K1[N] and vector V1[N] are stored in QKV system 510 (e.g., in an array of PNM SSD SoCs).

In some examples, QKV processing may include reading QKV history (e.g., K[0:QL][N], V[0:QL][N]), matrix multiplication, scoring by softmax, matrix multiplication, and outputting a compute result. The QKV processing may include a matrix multiplication operation (e.g., K[0:QL][N]×Q-T[N], K1{1˜2048}×Q1[N]). The QKV processing may include scoring by a softmax function (e.g., softmax [N], softmax [0:QL][N]). In some cases, the matrix multiplication operations may include softmax [0:QL][N]×V[0:QL][N], and/or softmax [N]×V1{1˜2048}). In some examples, K1{1˜2048} and V1{1˜2048} represent memory data sets (e.g., history query metrics). As query length is increased a given memory data set increases (e.g., from 1 up to 2048 characters based on a system limit of 2048 characters per query). K1{1˜4096} and V1{1˜4096} means that the data set may be from 1 to 4096 characters, and so on. When new metrics are added, QKV data is multiplied by the history query metrics (e.g., results of previous matrix multiplication). For example, K1[N] may be multiplied by history query metrics resulting in K1{1˜2048} (e.g., K1 with 1 to 2048 characters). Similarly, V1[N] may be multiplied by history query metrics resulting in V1{1˜2048} (e.g., V1 with 1 to 2048 characters).

In one or more examples, the QKV processing may include outputting a compute result (e.g., Output {Activation2[N]}). In some cases, query processing controller 515 may generate an output (e.g., MHA output MHA(O)) based on the QKV processing. In some cases, the process may include one or more reduce functions. In some examples, one or more activation functions may be implemented resulting in activation outputs (e.g., vector Activation1[N], vector Activation2[N], vector Activation3[N]). In some examples, Activation1[N] is an activation output from the embedding positional encoding process and Activation2[N] is an output of QKV system 510 based on at least one iteration of QKV processing of an input query (e.g., token index [N]).

In some examples, the QKV processing may identify and weigh the importance of different parts of an input sequence and the output may indicate how the different parts of the input sequence relate to one another (e.g., relevance between the different parts of the input sequence or tokens). In some cases, the compute result may be based on previous iterations of matrix multiplication (e.g., a second iteration of matrix multiplication based on a first iteration of matrix multiplication, a final iteration of matrix multiplication based on a second to last iteration of matrix multiplication or a culmination of previous iterations of matrix multiplication). In some cases, the query processing of QKV system 510 may include layered normalization. In some cases, the query processing may include feedforward processing. The query processing may include a decode function. As shown, the query processing may output an answer to the query. In some cases, one or more steps of the query processing may be repeated (e.g., repeat matrix multiplications some number of iterations such as 96 times, etc.).

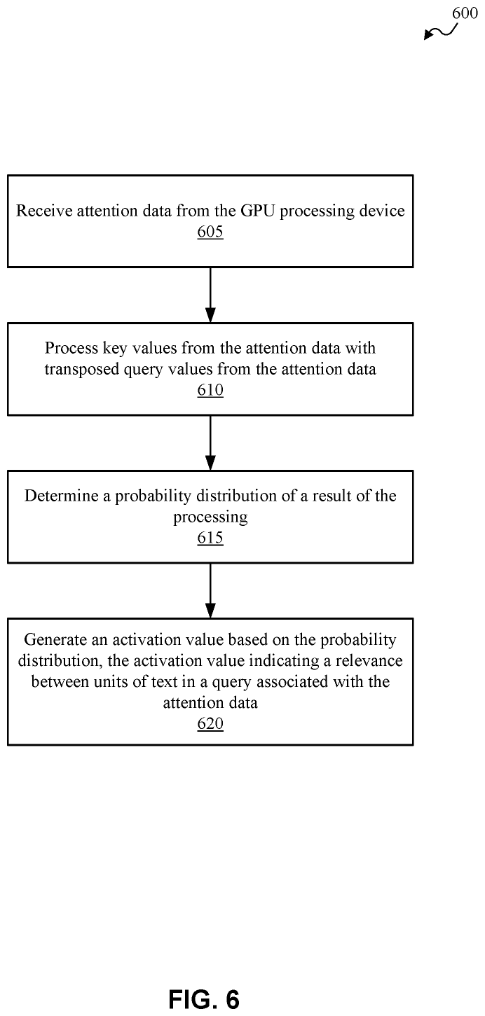

FIG. 6 depicts a flow diagram illustrating an example method 600 associated with the disclosed systems, in accordance with example implementations described herein. In some configurations, the method 600 may be implemented by query processing controller 140 of FIG. 1, query processing controller 230 of FIG. 2, PNM SSD SoC 305 of FIG. 3, QKV system 410 of FIG. 4, and/or query processing controller 515 of FIG. 5. In some configurations, the method 600 may be implemented in conjunction with machine 105, components of machine 105, or any combination thereof. The method 600 is just one implementation and one or more operations of the method 600 may be rearranged, reordered, omitted, and/or otherwise modified such that other implementations are possible and contemplated.

At 605, the method 600 may include receiving attention data from a GPU processing device. For example, query processing controller 140 may receive attention data from a GPU processing device. The attention data may include QKV data of a query (e.g., vector Q1[N], vector K1[N], vector V1[N]) that may be based on attention data of a previous iteration.

At 610, the method 600 may include processing key values from the attention data with transposed query values from the attention data. For example, query processing controller 140 may process key values from the attention data with transposed query values from the attention data.

At 615, the method 600 may include determining a probability distribution of a result of the processing. For example, query processing controller 140 may determine a probability distribution of a result based on the processing.

At 620, the method 600 may include generating an activation value (e.g., a set of activation values, an activation vector) based on the probability distribution, the activation value indicating a relevance between units of text in a query associated with the attention data. For example, query processing controller 140 may generate an activation value based on the probability distribution, where the activation value indicates a relevance between units of text in a query associated with the attention data.

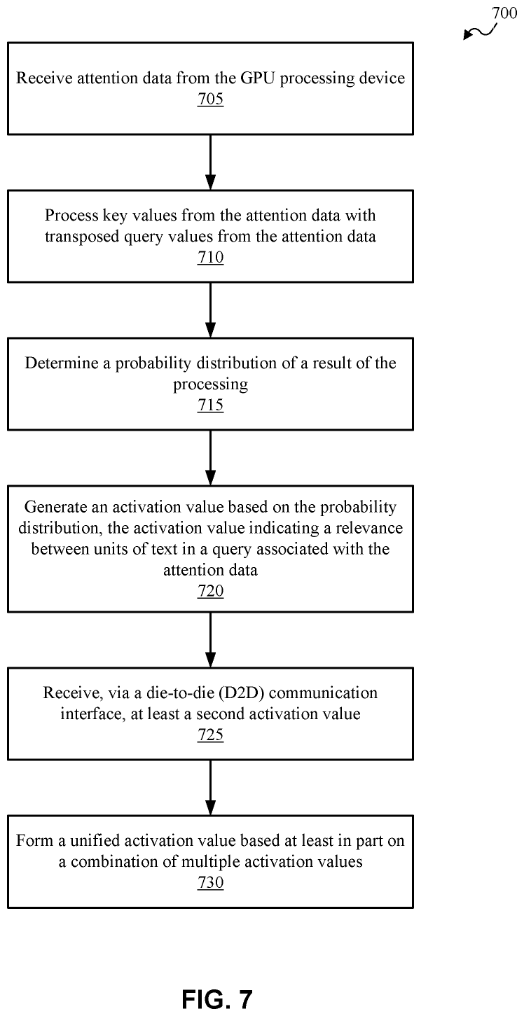

FIG. 7 depicts a flow diagram illustrating an example method 700 associated with the disclosed systems, in accordance with example implementations described herein. In some configurations, the method 700 may be implemented by query processing controller 140 of FIG. 1, query processing controller 230 of FIG. 2, PNM SSD SoC 305 of FIG. 3, QKV system 410 of FIG. 4, and/or query processing controller 515 of FIG. 5. In some configurations, the method 700 may be implemented in conjunction with machine 105, components of machine 105, or any combination thereof. The method 700 is just one implementation and one or more operations of the method 700 may be rearranged, reordered, omitted, and/or otherwise modified such that other implementations are possible and contemplated.

At 705, the method 700 may include receiving attention data from a GPU processing device. For example, query processing controller 140 may receive attention data from a GPU processing device.

At 710, the method 700 may include processing key values from the attention data with transposed query values from the attention data. For example, query processing controller 140 may process key values from the attention data with transposed query values from the attention data.

At 715, the method 700 may include determining a probability distribution of a result of the processing. For example, query processing controller 140 may determine a probability distribution of a result based on the processing.

At 720, the method 700 may include generating an activation value (e.g., a set of activation values, an activation vector) based on the probability distribution, the activation value indicating a relevance between units of text in a query associated with the attention data. For example, query processing controller 140 may generate an activation value based on the probability distribution, where the activation value indicates a relevance between units of text in a query associated with the attention data.

At 725, the method 700 may include receiving, via a die-to-die (D2D) communication interface, at least a second activation value (e.g., a second activation vector). For example, query processing controller 140 of a first PNM storage device may receive, via a D2D communication interface, at least a second activation value from a second PNM storage device.

At 730, the method 700 may include forming a unified activation value based at least in part on a combination of multiple activation values. For example, query processing controller 140 may form a unified activation value based at least in part on a combination of the first activation value of the first PNM storage device and the second activation value of the second PNM storage device, where the D2D communication interface enables the first PNM storage device and the second PNM storage device to communicate independent of the GPU processing device or a host.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example, a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples described herein set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of query processing, the method comprising:
receiving data at a first processing-near-memory (PNM) storage device;
processing, at the first PNM storage device, first values from the data with transposed second values from the data;
determining, at the first PNM storage device, a probability distribution of a result of the processing of the first values from the data with the transposed second values from the data; and
generating, at the first PNM storage device, an activation value based on the probability distribution, the activation value indicating a correlation between units of text in a query associated with the data.

2. The method of claim 1, wherein the first PNM storage device includes a memory that stores key-value data from the data.

3. The method of claim 2, wherein the memory and a processor of the first PNM storage device comprise an integrated circuit based on the memory being stacked on top of the processor and the memory being communicatively connected to the processor.

4. The method of claim 1, further comprising:
receiving, via a die-to-die (D2D) communication interface, at least a second activation value from a second PNM storage device; and
forming a third activation value based at least in part on a combination of the activation value of the first PNM storage device and the second activation value of the second PNM storage device, wherein the D2D communication interface enables the first PNM storage device and the second PNM storage device to communicate.

5. The method of claim 1, further comprising receiving, from the processing device, a trigger based on a hint ahead operation, wherein the trigger includes at least one of a user identifier or layer number information associated with the data.

6. The method of claim 1, wherein the data is a portion of multi-head attention data that is distributed among multiple PNM storage devices.

7. The method of claim 1, wherein the data includes a portion of query attention data from a first attention layer, a portion of key attention data from a second attention layer, and a portion of value attention data from a third attention layer.

8. The method of claim 1, wherein the data is based on an iteration of activation values generated based on partial outputs generated by multiple PNM storage devices that are combined to form a unified output.

9. The method of claim 8, wherein the multiple PNM storage devices include an array of solid-state drives.

10. The method of claim 1, wherein the first PNM storage device is a system on chip die that includes a solid-state drive and at least one processor that performs query processing.

11. The method of claim 1, wherein the first PNM storage device communicatively connects to the processing device via a high-bandwidth expansion bus.

12. The method of claim 1, wherein the processing device includes at least one graphical processing unit (GPU) communicatively connected to high-bandwidth memory.

13. The method of claim 2, wherein:
the data includes attention data,
the first values include key values,
the second values include query values, and
the key-value data includes a key-value matrix.

14. An query processing system, the query processing system comprising:
a processing device communicatively connected to a first processing-near-memory (PNM) storage device, the processing device to transmit data to the first PNM storage device; and
the multiple processing-near-memory (PNM) storage devices, the first PNM storage device to:
process first values from the data with transposed second values from the data;
determine a probability distribution of a result of the processing; and
generate an activation value based on the probability distribution, the activation value indicating a correlation between units of text in a query associated with the data.

15. The query processing system of claim 14, wherein the first PNM storage device includes a memory that stores key-value data from the data.

16. The query processing system of claim 15, wherein the memory and a processor of the first PNM storage device comprise an integrated circuit based on the memory being stacked on top of the processor and the memory being communicatively connected to the processor.

17. The query processing system of claim 14, wherein the first PNM storage device is configured to:
receive, via a die-to-die (D2D) communication interface, at least a second activation value from a second PNM storage device; and
form a unified activation value based at least in part on a combination of the activation value of the first PNM storage device and second activation value of the second PNM storage device, wherein the D2D communication interface enables the first PNM storage device and the second PNM storage device to communicate.

19. A non-transitory computer-readable medium storing code, the code comprising instructions executable by a processor of a first processing-near-memory (PNM) storage device to:
process, at the first PNM storage device, first values from data with transposed query values from the data;
determine, at the first PNM storage device, a probability distribution of a result of the processing; and
generate, at the first PNM storage device, an activation value based on the probability distribution, the activation value indicating a correlation between units of text in a query associated with the data.

20. The non-transitory computer-readable medium of claim 19, wherein:
the first PNM storage device includes a memory that stores key-value data from the data, and
the memory and a processor of the first PNM storage device comprise a integrated circuit based on the memory being stacked on top of the processor and the memory being communicatively connected to the processor.
